(19) United States
(12) Patent Application Publication
(10) Pub. No.: US 2012/0179898 A1
(43) Pub. Date: Jul. 12, 2012

(54) SYSTEM AND METHOD FOR ENFORCING SOFTWARE SECURITY THROUGH CPU STATISTICS GATHERED USING HARDWARE FEATURES

(75) Inventors: Pierre Betouin, Boulogne (FR); Jon McLachlan, San Francisco, CA (US); Gianpaolo Fasoli, Palo Alto, CA (US); Julien Lerouge, Santa Clara, CA (US); Ganna Zaks, Mountain View, CA (US); Augustin J. Farrugia, Cupertino, CA (US)

(73) Assignee: Apple Inc., Cupertino, CA (US)

(21) Appl. No.: 12/987,743

(22) Filed: Jan. 10, 2011

(51) Int. Cl. G06F 9/30

(52) U.S. Cl. 712/227; 712/E09.016

(57) ABSTRACT

This disclosure is directed to measuring hardware-based statistics, such as the number of instructions executed in a specific section of a program during execution, for enforcing software security. The counting can be accomplished through a specific set of instructions, which can either be implemented in hardware or included in the instruction set of a virtual machine. For example, the set of instructions can include atomic instructions of reset, start, stop, get instruction count, and get CPU cycle count. To obtain information on a specific section of code, a software developer can insert start and stop instructions around the desired code section. For each instruction in the identified code block, when the instruction is executed, a counter is incremented. The counter can be stored in a dedicated register. The gathered statistics can be used for a variety of purposes, such as detecting unauthorized code modifications or measuring code performance.

### BACKGROUND

1. Technical Field

The present disclosure relates to software protection and more specifically to detecting, during program execution, unauthorized modifications to computer programs.

2. Introduction

There are many examples of computer software that contain sensitive information, such as proprietary algorithms, security routines, or cryptographic keys. One prime example is Digital Rights Management software, which can contain a variety of highly sensitive information. Because of this, software is often the target of various attacks, like software tampering or reverse engineering, in which a user modifies the software as part of an effort to dissect, analyze, and discover how it works or to alter the functionality. In the currently used computing model, software is particularly vulnerable to tampering and reverse engineering attacks because the software is often executed in an open environment in which the user has full control. For example, when software is executed on a user's personal computer, which is running a commonly available operating system, e.g., Mac OS, Microsoft Windows, Linux, etc., the user is able to closely monitor the execution of the program. Even in more closely managed operating systems, such as mobile device operating systems, tools are available for the user to monitor and tinker with program execution. Furthermore, with the right skills and tools, the user can even alter the execution of the program.

A variety of techniques have been employed to address these vulnerabilities, such as code obfuscation and tamper resistance techniques. Unfortunately, most of these techniques are vulnerable to the same attacks to which unprotected software is vulnerable.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for gathering statistics related to the execution of the program and in some embodiments using the statistics to detect unauthorized modifications to a computer program. The statistics can include actual statistics as well as anything sequentially derivable, such as computing a hash chain to detect unauthorized access. A general-purpose computing device can be configured to gather the statistics by including a number of special purpose statistics gathering hardware instructions, such as a reset instruction counter, a start instruction counter, a stop instruction counter, a get instruction count instruction, and/or a get CPU cycle count instruction. When the computing device executes the instructions in a program it can perform specific actions for the statistics gathering instructions, such as resetting an instruction counter, starting or stopping the instruction counting, or fetching the instruction count value. In some embodiments, instead of hardware instructions, the special purpose statistics gathering instructions can be instructions included in a virtual machine.

To gather statistics on a specific section of code, a software developer can insert statistics gathering instructions around the desired code section. For each instruction inside the identified code block, a counter can be incremented when the instruction is executed. If the developer is only interested in the count for that code section, a reset instruction can be inserted prior to the start instruction. A get instruction count instruction can be used to get the count in the counter. The get instruction count instruction can be inserted right after the stop instruction, or anywhere else in the code prior to a reset instruction. In some cases, the counter can be stored in a dedicated register.

In some embodiments, a software developer can use the statistics gathering features to detect unauthorized changes to a computer program. For example, if an attacker modifies a monitored section of code by increasing or decreasing the number of instructions, the instruction count can be used to detect the change. Alternatively, in some embodiments, the statistics gathering features can be used to measure performance of a specific section of code. For example, different compiler optimizations and/or code protection mechanisms can have different effects on a monitored section of code. The statistics can be used to identify the code impact.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary technique of annotating the source code to insert the statistics gathering instructions;

FIGS. 3A and 3B illustrates four ways in which the statistics gathering instructions can be inserted to gather information about the number of instructions executed for a particular section of code;

FIG. 4 illustrates an exemplary register configuration to support system wide and thread specific counters;

FIG. 5 illustrates exemplary register states before and after a system wide resetInstCounter instruction;

FIG. 6 illustrates exemplary register states before and after a thread specific getInstCounter instruction;

FIG. 7 illustrates an exemplary technique of using the statistics gathering instructions to detect unauthorized code modifications;

FIG. 8 illustrates two exemplary techniques of using the statistics gathering instructions to measure program performance;

FIG. 9 illustrates an example method embodiment for gathering execution related statistics; and

FIG. 10 illustrates an example method embodiment for detecting modifications to a computer program.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

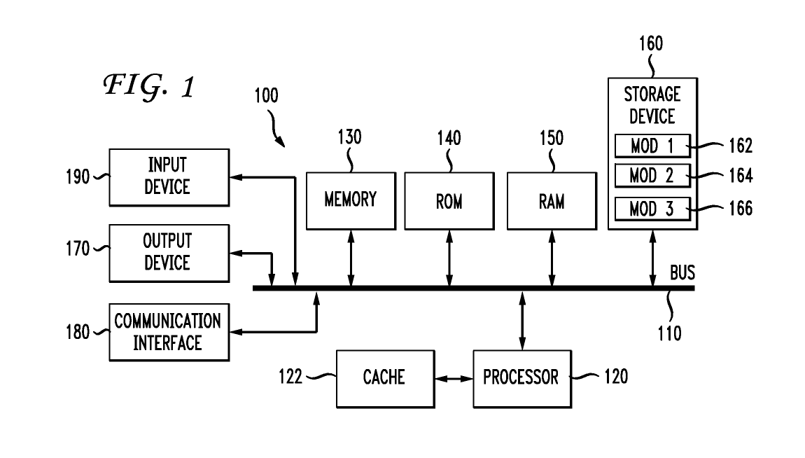

The present disclosure addresses the need in the art for improved methods of gathering computer program statistics and detecting, during program execution, unauthorized changes to the computer program. The approaches set forth herein can also be used for profiling performance of particular portions of the computer program, or for comparing the performance of executables generated by different compilers, for example. The disclosure first sets forth a discussion of a basic general-purpose system or computing device in FIG. 1 that can be employed to practice the concepts disclosed herein. The disclosure then turns to a detailed description of gathering execution statistics and several exemplary uses of the gathered statistics. Finally, the disclosure proceeds with two exemplary method embodiments. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some basic system components, the disclosure now turns to an introductory discussion of gathering execution statistics and a couple exemplary uses of those statistics. One way to gather information pertaining to the execution of a program accurately and efficiently is to implement a specific set of CPU instructions for the desired statistics. Once the information has been gathered, developers can use the statistics in a number of ways, such as to aid in detecting unauthorized modifications to the software or to measure or compare performance. The present disclosure is directed to gathering and using statistics regarding the number of instructions executed and/or CPU cycles completed for a particular section of computer executed code, however the principles disclosed herein can also be used to gather other information.

The statistics gathering instruction set can be incorporated in a CPU, a crypto-processor, or any hardware chipset executing sequences of instructions. The instruction set does not have to be dependent on any particular CPU capabilities or specifications. For example, the instructions can be implemented for a 16-bit, 32-bit, 64-bit, or other architecture. Additionally, the instructions can be implemented for a computer architecture that supports fixed width or variable width instructions.

While the disclosure discusses implementations of the statistics gathering capabilities as part of a hardware instruction set, one skilled in the art will recognize that these capabilities can also be implemented as part of a virtual machine using the same principles disclosed for the hardware implementation.

To allow a developer to gather statistics regarding the number of instructions executed and/or CPU cycles completed for a particular section of code, the system can include a set of instructions including a resetInstCounter instruction, a startInstCounter instruction, a stopInstCounter instruction, a getInstCounter instruction, and a getCPUCycleCount instruction. Each instruction can be an atomic instruction. The resetInstCounter instruction can be used to reset the instruction counter and/or CPU cycle counter to a default value, such as zero. The starting instruction can be used to start the instruction counting and or CPU cycle counting. Further, the system can count other similar actions taken by the computing device or components of the computing device. For example, the system can count instructions processed by a graphical processing unit, the number of bytes written to or read from memory, the number or order of accesses to registers in the CPU, and so forth. While the examples below discuss CPU cycles and instructions, metrics other than CPU cycles, as well as combinations thereof, can be used.

Once a start instruction has been executed, the instruction counter can be incremented for each instruction executed after the start instruction. The stopInstCounter instruction can stop the instruction counting and/or CPU cycle counting. Once a stopInstCounter instruction has been executed, the instruction counter will not be incremented again until a start instruction is executed. The getInstCounter instruction can be used to fetch the current value of the instruction counter. The getCPUCycleCount instruction can be used to fetch the current value of the CPU cycle counter. In some embodiments, alternative instructions can be used, such as instructions that permit gathering statistics that differentiate between the number of instructions executed system wide and the number of instructions executed on a specific execution thread.

A key to the statistics gathering is that at least one counter is maintained. The counter(s) can be implemented in a number of ways. For example, the counter(s) can be stored in one or more dedicated registers. Alternatively, the counter(s) can be stored in a dedicated section of memory. In some cases, it may be desirable to store a counter in a manner that is only modifiable by the dedicated hardware instructions or is at least difficult to modify by a user or other processes.

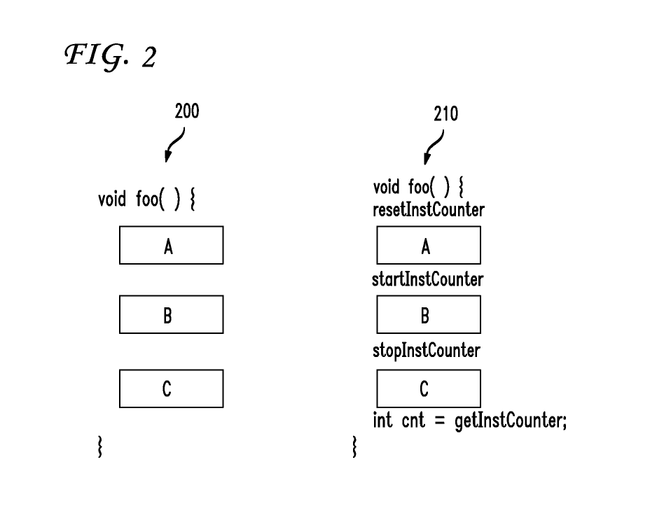

The statistics gathering instructions can be added to the software at various points in the software development. For example, in some cases, the developer can indicate the location and type of instruction that should be added to the compiled program by adding annotations or flags to the source code. These annotations can take the form of specially formed comments, preprocessor directives, macros, specific instructions, calls to a particular API, code formatting, and so forth. FIG. 2 illustrates an exemplary technique of annotating the source code to insert the statistics gathering instructions. In FIG. 2 the developer has a function 200, which performs some sequence of instructions that can be divided in code sections A, B, and C. The developer is interested in gathering statistics for code section B. To do this, the developer can insert annotations that represent the desired instructions around code section B as illustrated in the annotated function 210. In this case, the developer inserted a resetInstCounter instruction at the beginning of the function, the startInstCounter and the stopInstCounter instructions around the code section B, and the getInstCounter instruction at the end of the function. While this example shows a single section being monitored, the developer can flag multiple sections for monitoring and can overlap monitored sections with different flags, flag types, or layers of flags.

Alternatively, in some cases, the source code can be translated into an intermediate representation prior to indicating the location and type of instruction that should be added to the compiled program. In both of these cases, a compiler can then be used to produce the executable program with the desired statistics gathering capabilities embedded. In other cases, the developer can add the desired instructions at the assembly level after the source code has been compiled to an executable program.

The statistics gathering instructions can be inserted in the software in various points depending on the desired goals of the software developer. For example, to obtain information on a specific section of code, a software developer can insert startInstCounter and stopInstCounter instructions around the desired code section. For each instruction inside the identified code block, the instruction counter is incremented when the instruction is executed. If the developer is only interested in the count for that code section, a resetInstCounter instruction can be inserted prior to the startInstCounter instruction. The getInstCounter instruction can be used to get the count in the counter. The getInstrCount instruction can be inserted right after the stopInstCounter instruction, or anywhere else in the code prior to a resetInstCounter instruction. Alternatively, the developer can insert a getInstCounter instruction prior to a stopInstCounter instruction. This allows a developer to gather information at various points during the execution of a section of code instead of just at the completion of the code section.

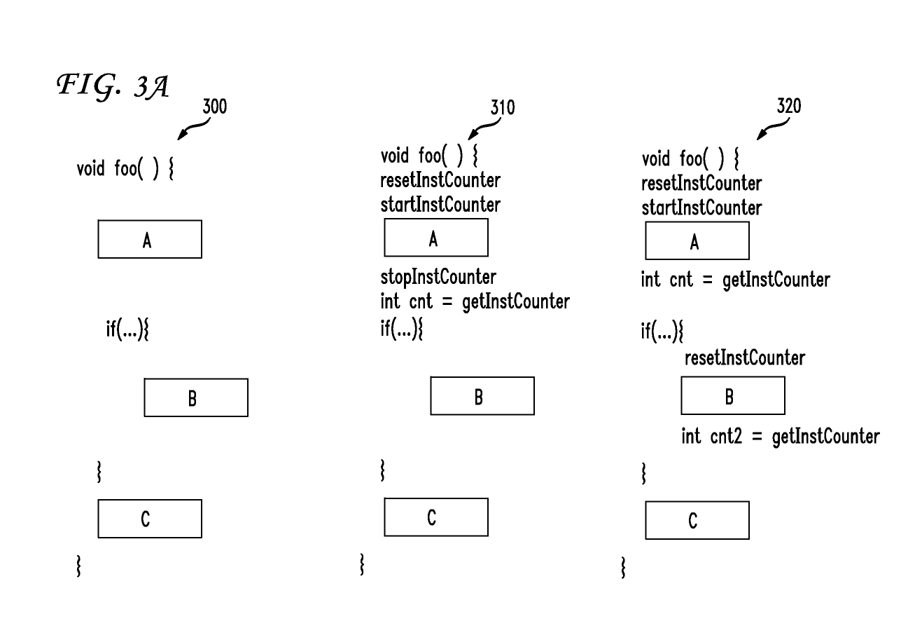

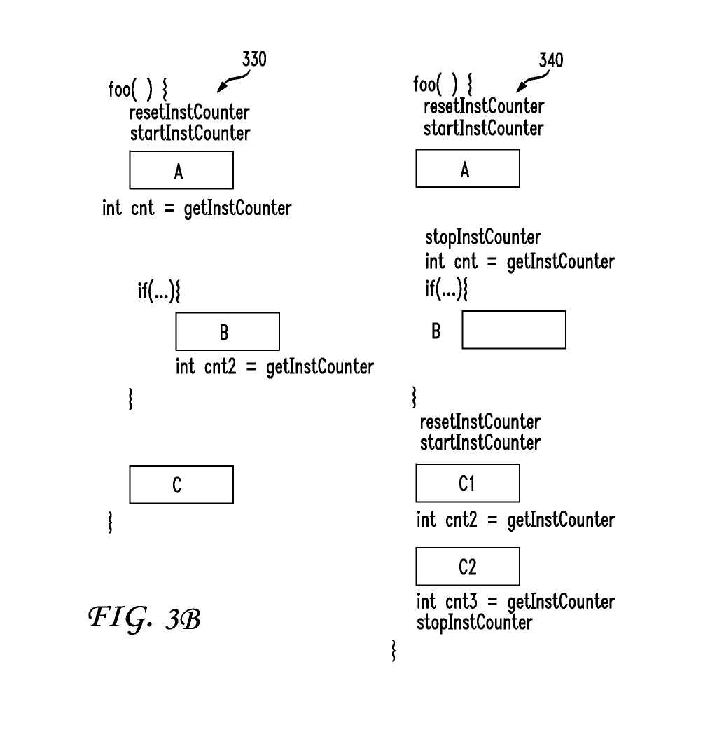

FIGS. 3A and 3B illustrates four ways in which the statistics gathering instructions can be inserted to gather information about the number of instructions executed for a particular section of code. In FIGS. 3A and 3B, function 300 illustrates the original function for which the developer is interested in gathering statistics. In function 310, the developer has concentrated the statistics gathering around code section A. The instruction counter is reset and the counting is started just prior to executing code section A. The counting is then stopped immediately after code section A and the value of the counter retrieved. In function 320, the developer is interested in the instruction count of two different code sections: A and B. In this case, the instruction counter is reset at the beginning of the function and the counting is started just prior to section A. The value of the counter is retrieved after code section A. If execution proceeds inside the if statement, the counter is reset again, but note that the counter was never stopped so it does not need to be restarted. After the code section B has completed execution, the counter value is fetched. In function 330, the developer is again interested in the instruction count at two points. However, in this case, the developer is interested in a cumulative instruction count. At the beginning of function 330, the counter is reset. Again, note that the counter is not being started, this is because the counter was previously started in another function on the call path to function 330 and never stopped so it does not need to be restarted. The value of the counter is then fetched after section A and section B. Finally, in function 340, the developer is not interested in the instruction count associated with code section B inside of the if statement. Additionally, note that the counter is stopped and restarted so that the counting does not continue when code section B is executed. There are of course, numerous ways that a developer can insert the instructions. The use, order, location, etc. can depend on the goals of the developer. The monitored portions of the code can be contiguous, non-contiguous, or overlapping.

As mentioned briefly above, in some embodiments, the instruction set can be implemented to permit gathering statistics that differentiate between the number of instructions executed system wide and the number of instructions executed on a specific execution thread. In this case, multiple registers can be used to maintain the counters. One possible register configuration 400 is illustrated in FIG. 4. In register configuration 400, register R1 is a status register that can provide information about the instructions to the CPU, such as the command ID, command options, error code, and success status. In this example, bits 0x00-0x07 can represent the command ID. For example, 0x01 can represent a reset request, 0x02 a start request, 0x03 a stop request, 0x04 a getInstCounter request, etc. Bits 0x08-0x15 can be used for command options. For example, enabling bit 0x15 can indicate the command specified in the command ID bits is a system wide command, while enabling bit 0x14 can indicate that it is a thread specific command. Additionally, bits 0x24-0x31 can be used as output bits. For example, bit 0x31 can be used to indicate whether a command was successful or not. If it was not successful, then bits 0x24-0x30 can be used to encode an appropriate error code. Register configuration 400 also includes registers R2 and R3 to maintain thread specific and system wide instruction counters, respectively. Enabling a bit can mean changing the value of that bit to 1, 0, or toggling the bit, depending on the implementation.

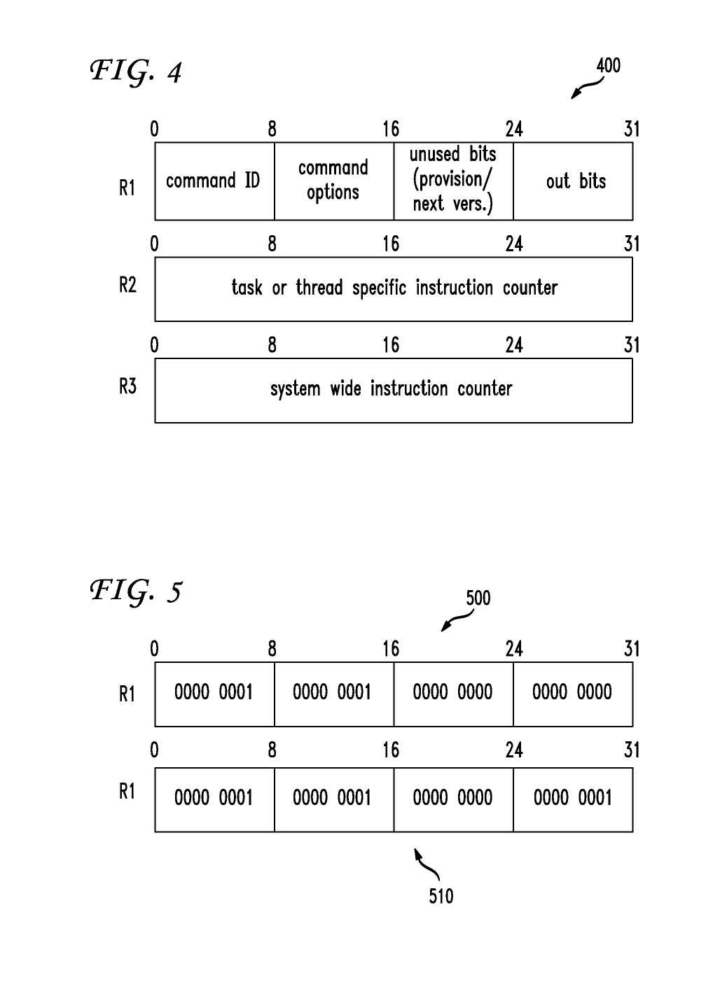

FIG. 5 illustrates exemplary register states before and after the execution of a system wide resetInstCounter instruction. The status register R1 500 depicts the register state just prior to execution. The command ID bits, bits 0x00-0x07, indicate the command is a reset and bit 0x15 is set so the command is a system wide command. Once execution of the resetInstCounter instruction has completed, the status register R1 is updated as reflected in register R1 510. In this case, execution was successful, as indicated by enabling the success bit, bit 0x31.

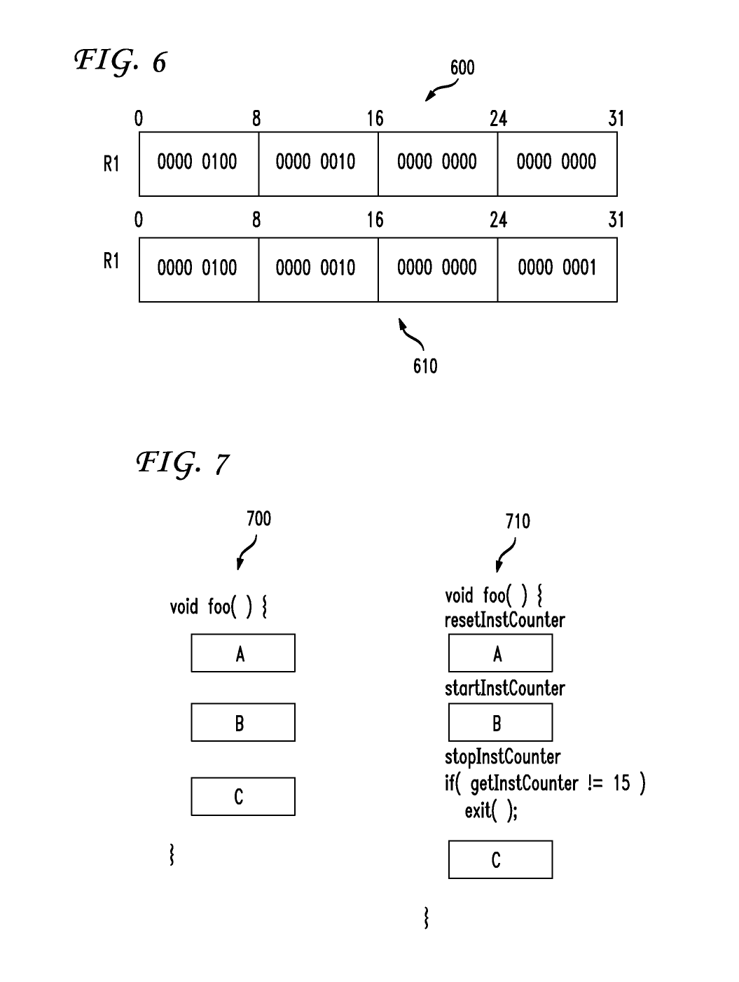

FIG. 6 illustrates exemplary register states before and after the execution of a thread specific getInstCounter instruction. The status register R1 600 depicts the register state just prior to execution. The command ID bits, bits 0x00-0x07, indicate the command is a getInstCounter and bit 0x14 is enabled so the command is a thread specific command. Once execution of the getInstCounter instruction has completed, the status register R1 is updated as reflected in register R1 610. In this case, execution was successful, as indicated by enabling the success bit, bit 0x31.

There are a number of different ways that a developer, a third party, and/or the system can use the statistics once gathered. These examples are discussed in terms of a developer, but a third party and/or the system can also perform these actions. In some cases, the statistics can be used to detect unauthorized code modifications. As part of a code protection mechanism, the developer can identify one or more sensitive sections of code. Once identified, the developer can insert appropriate statistics gathering instructions around the selected code sections. The developer can determine at compile time the number of instructions that should be executed in a selected code section. The developer can then incorporate this expectation in a protection mechanism of their choice, such as sending an error message to a remote computer or to a local display, corrupting key data, quitting program execution, requesting some additional user authentication, and so forth. By strategically placing the instructions, an attack that increases or decreases the number of instructions in a code section can be detected at run time. If the number of instructions executed does not match the expectation, the protection mechanism can react appropriately. For example, the instruction count may be useful in detecting a modification in which an attacker has tried to remove or bypass a security check by removing instructions. Alternatively, the instruction count may also be useful in detecting the presence of a debugger when an attacker has inserted a breakpoint in a monitored section of code.

FIG. 7 illustrates an exemplary technique of using the statistics gathering instructions to detect an unauthorized code modification. In this example, function 700 is the original, unprotected code. Function 700 includes three code sections: A, B, and C. In this case, the developer has identified code section B as a sensitive code section. The developer has also determined that the code section is defined by fifteen assembly instructions. To protect this section of code the developer inserts statistics gathering instructions as reflected in the protected function 710. The counting is isolated to the instructions in code section B. To detect authorized modifications to code section B, the developer has added a check after the code section B. If the number of instructions executed is not equal to the expected number of 15, the program quits. Other techniques of using the statistics gathering instructions to detect and/or react to unauthorized code modifications are also possible. The checks can be widespread everywhere in the program so patching it would become tiresome. Further, the complexity of the check can be enhanced in the software by obfuscation, encryption, and/or other approaches to make reverse engineering more difficult, complicated, and/or cumbersome.

Statistics gathering instructions can aid in measuring performance of one or more sections of code. A variety of factors can impact the performance of a program, such as compiler optimizations, use of external and uncontrolled APIs, etc. For example, some compiler optimizations can increase code size in exchange for a speed increase, decrease performance at the expense of other priorities, or make changes that do not provide any real benefit. The statistics gathering instructions can be used to identify unexpected performance or size bottlenecks or simply to perform a performance audit of particular code sections or the program as a whole.

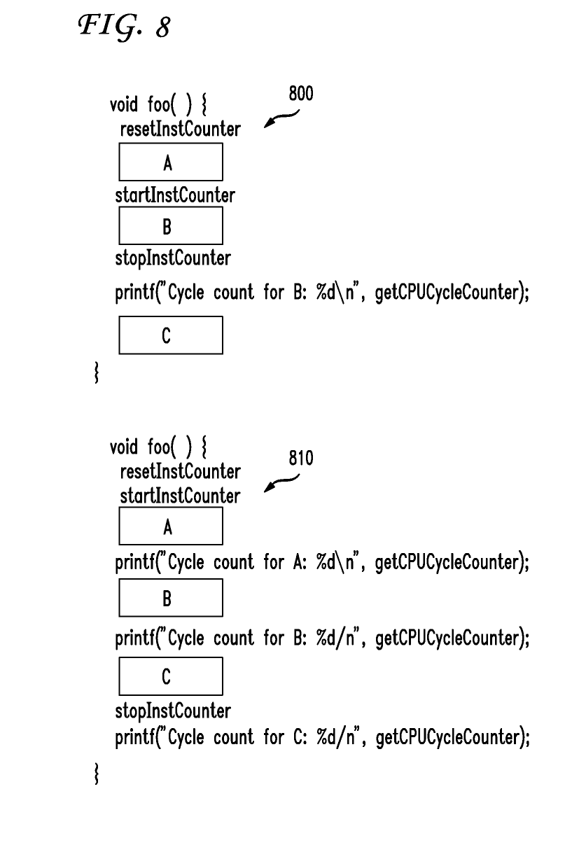

FIG. 8 illustrates two exemplary techniques of using the statistics gathering instructions to measure program performance. In the first example, the developer is only interested in the performance of a particular section of code: code section B in function 800. In this case, the counting is started immediately before code section B and stopped immediately after. The CPU cycle count is then reported for the code section. The technique used in function 800 can be useful in performance testing. For example, if code section B is a critical section of code, the developer can use the statistics to monitor the performance as the code evolves and/or as different code transformations are applied, such as compiler optimizations. This approach can be used to evaluate performance of different compilers. For example, the developer can compile the same code with two different compilers and determine how many CPU cycles are required to execute section B in the output of each compiler. This approach can even be used to compare the output of the same compiler with different settings. For example, the developer can compare the number of CPU cycles for output of the same compiler using different compiler options such as -xtarget=generic, -xtarget=generic64, -g -O, -g -fast, -xipo, and so forth.

In the second example, the developer is interested in gathering an overall performance profile of the function 810. In this case, the developer starts the counter at the beginning of the function and makes periodic checks of the CPU cycle counter. This technique can be useful in identifying performance hotspots, monitoring code performance as a program evolves (such as between daily builds or between different release versions), etc. Other techniques of using the statistics gathering instructions to measure performance are also possible, such as incorporating the getInstCounter instruction. The CPU cycle counting can be incorporated into an existing command, such as a loop.

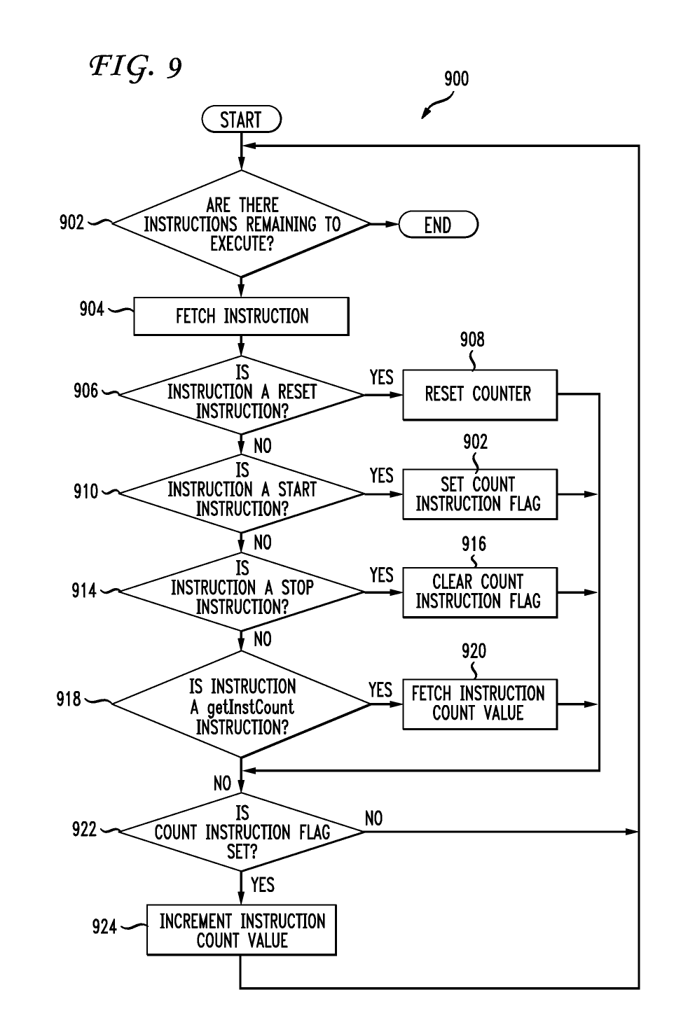

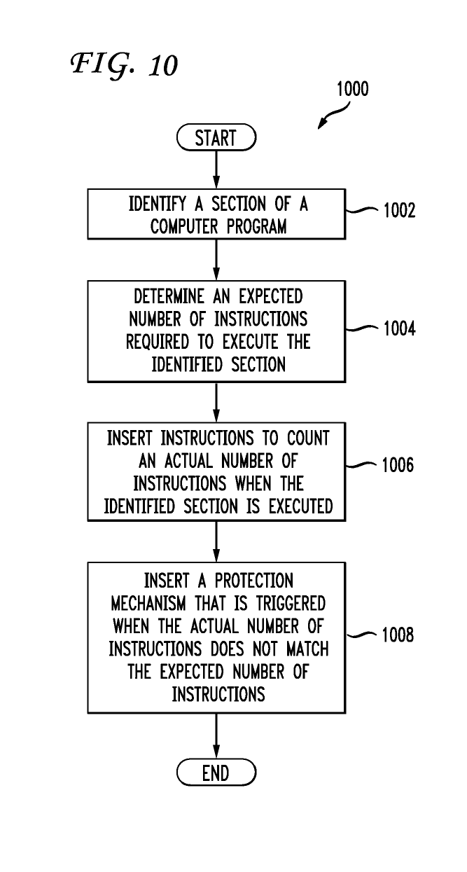

Having disclosed some basic system components and concepts, the disclosure now turns to an exemplary method embodiment shown in FIG. 9. For the sake of clarity, the method is discussed in terms of an exemplary system such as is shown in FIG. 1. Although specific steps are shown in FIG. 9, in other embodiments, a method can have more or less steps than shown. The method steps discussed in this and other figures can be implemented in the shown order or combination, or in any other order or combination.

The exemplary method 900 in FIG. 9 can be used to gather statistics related to the execution of a program by processing each instruction. At step 902 the system 100 checks if there are instructions remaining to execute. If there are instructions, the system 100 fetches the next instruction (904) and begins processing the next instruction by examining the type of instruction and performing an action specific to that instruction type, if applicable. If the instruction is a resetInstCounter instruction (906), the system 100 resets the instruction counter (908). If the instruction is a start instruction (910), the system 100 sets the count instruction flag (912). If the instruction is a stopInstCounter instruction (914), the system 100 clears the count instruction flag (916). If the instruction is a getInstCounter instruction (918), the system 100 fetches the instruction count value (920). In each of steps 908, 912, 916, and 920, depending on the configuration of the system, additional or alternative counters and/or flags can manipulate, e.g. CPU cycle counter, system wide instruction counter, thread specific instruction counter, count CPU cycle flag, etc. In some embodiments, the system can process different instruction types or additional instruction types, such as a getCPUCycleCount instruction and/or instructions that differentiate between system wide, thread specific, and processor core specific statistics, for example.

After processing the instruction type and performing any necessary actions, the system 100 checks if the count instruction flag is set (922). If the flag is set, the system 100 increments the instruction count value (924). In some embodiments, additional or alternative counters can be incremented, e.g. CPU cycle counter, system wide instruction counter, thread specific instruction counter, etc. After incrementing the counter, or if the count instruction flag is not set, the system 100 returns to step 902 to see if there are more instructions to process.

FIG. 10 illustrates an exemplary method for inserting checks into a computer program. For the sake of clarity, the method is discussed in terms of an exemplary system such as is shown in FIG. 1. The system can be a computing device running a software tool to insert the checks, for example. Although specific steps are shown in FIG. 10, in other embodiments, a method can have more or less steps than shown. The method steps discussed in this and other figures can be implemented in the shown order or combination, or in any other order or combination.

The exemplary method 1000 in FIG. 10 can use the statistics gathering instructions to detect unauthorized modifications to one or more sections of code in a computer program. The system 100 can identify a section of a computer program for which an instruction count should be gathered (1002). In some embodiments, the system 100 can randomly choose the code section. In some configurations, the system 100 can identify the code section by analyzing the program and choosing sections that satisfy a predefined set of criteria. The system 100 can also identify a code section by locating predefined annotations that are used to designate a code section. Additional methods of identifying a code section are also possible.

After identifying a code section, the system 100 can determine an expected number of instructions that are required to execute that code section (1004). In some embodiments, the system can do this by directly and/or statically analyzing the code. For example, if the code is in an executable format, the system may be able to simply count the number of instructions in the code section. Alternatively, the code may be in some other format, such as source code, in which case, the system 100 may need to transform the code prior to determining the number of instructions. For example, the system 100 may need to compile the code before determining the number of instructions.

After identifying the code section, the system 100 can insert instructions to count an actual number of instructions that are required to execute the code section (1006). In some embodiments, the system 100 can insert instruction counting instructions, such as the reset, start, stop, and getInstCounter instructions by identifying annotations that indicate the appropriate instruction type and location. The system 100 can also be configured to insert instruction counting instructions through other means, such as by analyzing the program to identify the appropriate instruction type and location.

The system 100 can also insert a protection mechanism that makes use of the expected and actual instruction count values (1008). The expected instruction count value can be one value, multiple values, and/or a range of valid values. In some embodiments, the system 100 can randomly choose a protection mechanism to insert from a set of predefined protection mechanisms. The system can also be configured to analyze the code and select a protection mechanism based on a predefined set of criteria. Alternatively, in some embodiments, the system can be configured to insert a particular protection mechanism. For example, the system can receive a command indicating the protection mechanism to insert or the code can contain an annotation or other notation that indicates the protection mechanism the system 100 should insert.

In some embodiments, a developer or a computer program, such as a compiler, can perform method 1000. For example, the developer can visually inspect the program to identify a section of code to protect using instruction counting (1002). After identifying a section, the developer can determine the number of computer instructions required to execute the code section (1004). The expected number of instructions can be determined in a number of ways. For example, the developer can compile the program, identify the code section in the executable, and count the number instructions with an automated tool. After identifying a code section, the developer can also insert instruction count instructions at various points in the program. The type of instructions inserted and the insertion location can vary depending on the protection goals of the developer. In some embodiments, the developer can insert annotations that represent the desired instructions and are later replaced by the actual instructions by another tool, such as a compiler. Alternatively, in some embodiments, the developer can manipulate the program at the assembly level and can directly insert the appropriate assembly instructions. The developer can also insert a protection mechanism that makes use of the expected and run-time instruction count values (1008). In some cases, the protection mechanism can take the form of a comparison, such as that used in function 710 in FIG. 7. In other cases, the developer can integrate the instruction count values in other software protect techniques.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of monitoring execution of a computer program, the method comprising:
receiving, at a processor, a first request to start monitoring, wherein the first request is triggered by a first instruction;
monitoring execution of the computer program by incrementing an instruction counter value for each executed instruction in the computer program;
upon receiving a second request to stop counting triggered by a second instruction, stopping monitoring execution of the computer program; and
in response to a third request triggered by a third instruction, returning the instruction counter value.

2. The method of claim 1, wherein the first request comprises a request to do at least one of reset an instruction counter triggered by a reset instruction, start counting executed instructions triggered by a start instruction, stop counting executed instructions triggered by a stop instruction, get an instruction count value triggered by a get instruction counter instruction, and a get a CPU cycle count value triggered by a get CPU cycle count instruction.

3. The method of claim 2, wherein each of the first, second, and third instructions is an atomic hardware instruction.

4. The method of claim 2, wherein each of the first, second, and third instructions is part of a set of virtual machine instructions.

5. The method of claim 1, wherein the instruction counter value is fetched from a register.

6. The method of claim 1, wherein the instruction counter value is specific to an individual process thread.

7. The method of claim 6, wherein the instruction counter value changes at a context switch.

8. The method of claim 1, further comprising:
generating a report comprising at least one of a system wide instruction count value, a system wide CPU cycle count value, a thread specific instruction count value, and a thread specific CPU cycle count value.

9. A non-transitory computer-readable storage medium storing instructions that, when executed by a computing device, cause the computing device to check for modifications to a computer program, the instructions comprising:
resetting an instruction count value to a default value;
triggering a processor to increment an instruction count value for each instruction executed in the computer program;
triggering the processor to stop incrementing the instruction count value;
fetching the instruction count value; and
generating a flag when the instruction count value does not match an expected value.

10. The non-transitory computer-readable storage medium of claim 9, wherein the instruction count value is stored in a dedicated processor register.

11. The non-transitory computer-readable storage medium of claim 9, wherein the instructions comprise atomic special purpose hardware instructions.

12. A method of detecting modifications to a computer program, the method comprising:
identifying a section of a computer program;
determining an expected number of instructions required to execute the section;
inserting, in the computer program, a first instruction before the section and a second instruction after the section to count an actual number of instructions when the section is executed; and
inserting, in the computer program, a protection mechanism that is triggered when the actual number of instructions does not match the expected number of instructions.

13. The method of claim 12, wherein the first and second instructions comprise at least one of a reset instruction, a start instruction, a stop instruction, a get instruction count instruction, and a get CPU cycle count instruction.

14. The method of claim 12, wherein the first and second instructions are inserted based on annotations that specify a location to insert and a particular instruction type to insert.

15. A system comprising:
a processor;
a storage medium storing a set of instructions;
a first module configured to control the processor to receive a notification to reset an instruction counter;
a second module configured to control the processor to receive a notification to count a number of instructions executed in an identified section of the set of instructions; and
a third module configured to control the processor to fetch a count value corresponding to the number of instructions.

16. The system of claim 15, wherein the second module comprises:
a fourth module configured to control the processor to receive a notification to start counting instructions executed;
a fifth module configured to control the processor to increment an instruction counter for each instruction executed while a notification to stop counting has not been received; and
a sixth module configured to control the processor to receive the notification to stop counting instructions executed.

17. The system of claim 15, wherein a notification is triggered by an instruction in the set of instructions, and wherein the set of instructions comprise at least one atomic instruction.

18. The system of claim 17, wherein the at least one atomic instruction comprises at least one of a reset instruction, a start instruction, a stop instruction, a get instruction count instruction, and a get CPU cycle count instruction.

19. The system of claim 15, wherein the count value is fetched from a processor register.

20. The system of claim 15, wherein the count value is specific to an individual process thread based on context switching.

21. A system for compiling, from source code, assembly code that enforces software security, the compiler comprising:
a processor;
a first module configured to control the processor to receive the source code and settings associated with the source code;
a second module configured to control the processor to identify a protected portion of the source code;
a third module configured to control the processor to determine, based on the protected portion, the settings associated with the source code, and compiler software characteristics, an expected number of instructions for executing the protected portion;
a fourth module configured to control the processor to compile the source code to yield assembly code;
a fifth module configured to control the processor to insert, in the assembly code, a first trigger that, when the assembly code is executed by an executing device, triggers the executing device to start counting executed instructions;
a sixth module configured to control the processor to insert, in the assembly code, a second trigger that, when the assembly code is executed by the executing device, triggers the executing device to stop counting executed instructions;
a seventh module configured to control the processor to insert, in the assembly code, a third trigger that, when the assembly code is executed by the executing device, triggers the executing device to perform a comparison of a counted number of executed instructions with the expected number of instructions; and
an eighth module configured to enforce software security based on the comparison.

22. The system of claim 21, wherein the first and second triggers comprise at least one of a resetInstCounter instruction, a start instruction, a stopInstCounter instruction, a get instruction count instruction, and a get CPU cycle count instruction.

23. The system of claim 21, wherein the first and second triggers are inserted based on annotations in the source code, wherein each annotation specifies a particular instruction type to insert and a location in the source code to insert the particular instruction type.
